(19) United States
(12) Patent Application Publication
(10) Pub. No.: US 2008/0109517 A1
(43) Pub. Date: May 8, 2008

(54) Scheduling a conference in situations where a particular invitee is unavailable

(75) Inventors: Shantanu Sarkar, San Jose, CA (US); Sravan Vadlakonda, Sunnyvale, CA (US); Ashish Chotai, Santa Clara, CA (US); Aseem Asthana, San Jose, CA (US)

Correspondence Address: THE LAW OFFICES OF BRADLEY J. BEREZNAK, 800 WEST EL CAMINO REAL, SUITE 180, MOUNTAIN VIEW, CA, 94040, US

(73) Assignee: Cisco Technology, Inc., San Jose, CA (US)

(21) Appl. No.: 11/595,133

(22) Filed: Nov. 8, 2006

(51) Int. Cl. G06F 15/16

(52) U.S. Cl. 709/206

(57) ABSTRACT

In one embodiment, a method includes sending an electronic invitation to an endpoint associated with a user. The electronic invitation requests that the user attend a conference session to be held at a specified time over a network. A set of filtering rules is then applied to the electronic invitation to select a delegate to attend the conference session in place of the user. Once a delegate has been selected, the electronic invitation is forwarded to the delegate. It is emphasized that this abstract is provided to comply with the rules requiring an abstract that will allow a searcher or other reader to quickly ascertain the subject matter of the technical disclosure.

### FIELD OF THE INVENTION

The present disclosure relates to the field of electronic calendaring and scheduling of meetings.

### BACKGROUND OF THE INVENTION

Calendaring software programs and scheduling tools are commonly used to check the electronic calendar of business team members for available time slots, to schedule meetings, and notify/remind invited meeting participants of the meeting by electronic mail (email). A person who wants to organize and schedule a meeting may view the available time slots for potential participants to automatically specify a suitable meeting time based on the collective availability of these individuals. By way of example, Internet protocol (IP) communication system products such as Cisco's MeetingPlace™ conferencing application allow users to schedule meeting conferences in advance. Other scheduling systems, such as the Calendar Facility of Microsoft® Outlook, provide a user with the ability to propose a meeting time to one or more other users. For instance, in the Calendar Facility, the system typically checks the schedule of potential participants and sends a message to each one asking them to attend. Generally speaking, meetings are not scheduled unless all (or a specified set) of the participants are available.

Prior art meeting scheduling systems suffer from the general inability to ascertain alternative meeting participants and to invite them in situations where a particular invitee is unable to attend. This can occur, for example, when a meeting invitee is unable to attend due to the fact that they are away on vacation. In many systems, a person has the ability to block off vacation time on their calendar, which typically results in the scheduler picking the first available time slot when they return. This approach is inadequate in cases where the scheduled meeting is urgent, such as in an emergency or crisis situation. Alternatively, if a person does not block off the dates/times that they are unavailable, the scheduler might send out an invitation that is either declined or goes unanswered, which could result in a meeting being held without the benefit of the knowledge or information that could have otherwise been provided by a key participant. Some applications do allow a user to select a delegate or alias for attending a meeting, but the selection is static insomuch as the delegation usually applies to all meetings, i.e., irrespective of meeting context or other considerations.

### BRIEF DESCRIPTION OF THE DRAWINGS

The present invention will be understood more fully from the detailed description that follows and from the accompanying drawings, which however, should not be taken to limit the invention to the specific embodiments shown, but are for explanation and understanding only.

FIG. 1 illustrates an example scheduling/conferencing system with multiple endpoints.

FIG. 2 illustrates an example method for auto-scheduling a conference session where an invitee may be unavailable at a scheduled time.

FIG. 3 illustrates an example network device.

### DETAILED DESCRIPTION OF EXAMPLE EMBODIMENTS

In the following description specific details are set forth, such as device types, configurations, specific algorithms, etc., in order to provide a thorough understanding of the present invention. However, persons having ordinary skill in the relevant arts will appreciate that these specific details may not be needed to practice the present invention.

According to one embodiment of the present invention, a meeting or conference (both terms are used interchangeably in the present application) scheduling system provides a mechanism to delegate meeting participation for users who are unavailable for any reason (e.g., away on vacation). A delegate is selected automatically by the system using a filtering algorithm in which a set of filtering rules are applied to an invitation message sent to the original invitee. The filtering rules are applied to the content of the invitation and are based on selection criteria such as certain words or phrases contained in the message subject field, message body, and recipient field. The filtering rules may also apply to criteria such as the message priority, and/or the scheduled time of the meeting.

It should be understood that in the context of the present application a conference or meeting scheduler comprises hardware, software and/or firmware program designed to assist a group of colleagues to electronically schedule meetings and other appointments. The scheduler program allows members of a group to view each others calendars so that they can choose a convenient time. Once a time has been selected, the scheduler can automatically send out reminders through e-mail and can even reserve resources (such as conference rooms, overhead projectors, etc.).

In a specific embodiment, the present invention may be implemented by software or hardware (firmware) installed in endpoint devices (e.g., a personal computer), conference servers, schedulers, or other conferencing system components, including applications such as Cisco System's MeetingPlace™, Microsoft® Outlook, Yahoo® Calendar, and/or other scheduling, calendaring, and conferencing products. Additionally, the signaling path utilized for transmission of commands, messages, and signals for scheduling, calendaring, establishing, moderating, managing, and controlling a given conference session may be across any network resources. Practitioners in the art will understood that the software or firmware installed in the systems and components mentioned above may be adapted or modified to implement the functions and capabilities described herein.

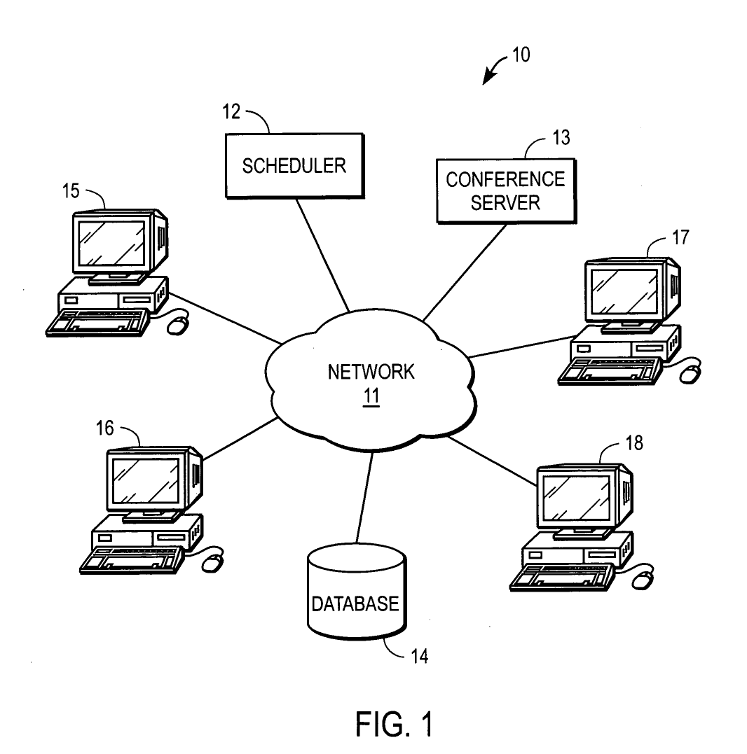

FIG. 1 illustrates an example scheduling/conferencing system 10 with multiple endpoints 15-18. Each of the endpoints is shown connected with a conferencing server 13, scheduler 12, and a database 14 via network 11, which may comprise an Internet Protocol (IP) network. In this example, endpoints 15-18 each comprise personal computers (PCs) running email and calendaring client applications, with capabilities for communicating with other endpoints, scheduler 12, server 13, as well as for accessing database 14 via network 11. Each of endpoint devices 15-18 includes a processor and executable code that supports the functionality described below. Other endpoint devices not specifically shown in FIG. 1 that may be used to initiate or schedule or participate in a conference session include a personal digital assistant (PDA), a laptop or notebook computer, or any other device, component, element, or object capable of initiating or participating in voice or packet-data exchanges with system 10 in accordance with the protocols and methods described herein.

Scheduler 12 is shown in FIG. 1 comprising a logical entity that is separate from conference server 13. It is appreciated that in some implementations scheduler 12 may be included in the same physical device as conference server 13. Conference server 13 may therefore comprise an integrated conferencing or meeting scheduling system application that includes software (or firmware) plug-ins, modules, or enhancements that implement the various features and functions described herein. In a specific implementation, for example, conferencing server 13 may run a modified or enhanced IP communication system software product such as Cisco's MeetingPlace™ conferencing application that allows users to schedule and attend meeting conferences. In the embodiment shown, conference server 13 handles all of the control plane functions of the conference session and manages audio transmissions and communications from the endpoints.

A user who wants to initiate or schedule a conference session may send an initial communication or request to scheduler 12 that includes the list of invitees and a proposed meeting time. Assume, for example, that the user (“Andy”) of PC 15 wants to schedule a meeting among the users of PCs 16-18 for next Wednesday at 10:00 a.m. Scheduler 12 receives this request from PC 15 and responds by sending a communication (e.g., invitation via email) to each of PCs 16-18. The invitation message may include a meeting subject field, a scheduled date/time, recipient (invitee) list, and a message body containing a brief explanation of the agenda (or other details) of the meeting. In some cases, the scheduler may view the calendaring programs running on PCs 16-18 to view whether a different time/date would better fit the personal calendars of each of the invited participants.

Continuing with the example of FIG. 1, assume that Bob, the user of PC 16, has set his calendar program and/or email client to indicate that he is on vacation during the scheduled meeting time. In one embodiment, PC 16 responds to the invitation by sending back a reply message that communicates Bob's unavailability. Scheduler 12 then responds by executing an algorithm to select a delegate to attend the conference session in place of Bob. The selection may based on a predefined criteria (i.e., logical filtering rules) applied to the invitation originally sent. The filtering rules and pool of available delegates may be predefined by Bob and stored in database 14.

On a meeting-by-meeting basis, scheduler 12 may access database 14 and apply the predefined rules to select an appropriate delegate to attend the conference session in place of the Bob, the original invitee. For example, the filtering algorithm specified for Bob's meetings may search for certain key words or phrases in the subject or body of the invitation. If, for example, the word “sales” in included in the invitation message, Bob may have preset Frank as the appropriate delegate to attend the meeting in his place. Alternatively, if the invitation includes an “urgent” priority setting, Bob may have designated Tom as the delegate to attend the meeting. By way of further example, Bob may designate Sam as the delegate for all meetings held from Mar. 10, 2007 to Mar. 17, 2007, or Ravi as the delegate whenever the specified meeting time is between 6:00 p.m. to 8:00 a.m. Pacific Time. The filtering rules created by Bob may comprise a list words or phrases (i.e., content), priority settings, meeting requestor/originator information, time of the meeting, location of the meeting, any combination of these or any other contextual information related to the meeting. One or more delegates are associated with each entry in the list. In other words, a user may create a preference hierarchy of persons to be selected as a delegate for a meeting that matches certain pre-specified criteria. For a given meeting invitation, therefore, scheduler executes an algorithm that applies the set of filtering rules associated with an unavailable invitee in an attempt to match the pre-specified filtering criteria with a delegate.

In another embodiment, the delegation functionality may be implemented in the calendaring program or email client running on the invitee's endpoint device. That is, when an invitation to attend a meeting is sent to the PC of a user who is on vacation or otherwise unavailable, that user's PC executes code to provide delegation based on a set of filtering rules as described above. For instance, when a meeting invitation is sent to Bob with a specified time when he is on vacation, his PC (endpoint 16 in the example of FIG. 1) may select a delegate (e.g., Tom) and forward the invitation directly to that person. Bob's PC may also inform scheduler 12 of his inability to attend as well as the selection of Tom as his delegate.

In certain implementations, multiple delegates may be selected to cover for a specific person who is unavailable. That is, the filtering rules may be configured to select two or more delegates to replace a single individual who is unable to attend a given meeting.

It should be understood that the logical filtering rules may reside on an email server, calendaring program, scheduler, or other server. The filtering rules may also reside on a client or be exercised on a browser based interface. In various embodiments, the filtering rules may be fetched by the scheduler when the initial request to schedule the meeting is received, in response to a message indicating that an invitee participant is unavailable at a specified meeting time, or by the endpoint device when the meeting invitation is received. Furthermore, in certain embodiments the logical filtering rules may be overridden or modified dynamically by the associated user or the meeting organizer. For instance, during the middle of his vacation Bob may learn that Tom has taken an emergency leave of absence. While he is on vacation, Bob may therefore modify his specified filtering rules and list of delegates accordingly.

In still another embodiment, the delegate has the ability to bounce back the invitation to the original invitee, thus triggering the remaining filters in the set of delegation filters and possibly allowing for a different delegate to pick up the meeting. For instance, in the example above, assume that the selected delegate, Tom, also happens to be on vacation or is otherwise unavailable at the specified meeting time. Upon receiving the forwarded invitation, Tom's PC may send a reply message to Bob's PC (or to the scheduler) indicating that he is unavailable. Upon receiving the reply, Bob's set of pre-specified filtering rules may be used to select another delegate to attend the meeting, but this time excluding Tom from the pool of available delegates. This process may continue until a delegate that matches the filtering criteria is found. Thus a delegation can trickle down to multiple levels.

In a specific implementation, the filtering rules may also include a default delegate designation; that is, a delegate to select in the event that no match is found after application of the filtering rules to context provided by the invitation message.

In still another embodiment, meetings may be classified, e.g., as “delegatable” or “non-delegatable”. For example, a “delegatable” or “non-delegatable” property may be attached or associated with an invitation sent by the scheduler. When a conference session is “delegatable”, the rules of delegation may be applied in the event that an invitee participant is unavailable, or if the participant elects to delegate the conference to someone else. If a conference session is “non-delegatable”, the rules of delegation are not applied in the event that an invitee participant is unavailable. In other words, nobody is selected as a delegate to attend a meeting in place of an original invitee when the original invitee is unavailable.

In yet another embodiment, during an on-going conference session a delegate may detect the presence of the original invitee (e.g., logged onto his computer) and send a message to that person requesting a transfer of the conference session directly to him. The original invitee may join the conference session upon his acceptance of the transfer. The role of the moderator of a conference session may also be delegated to one of the attendees in this manner.

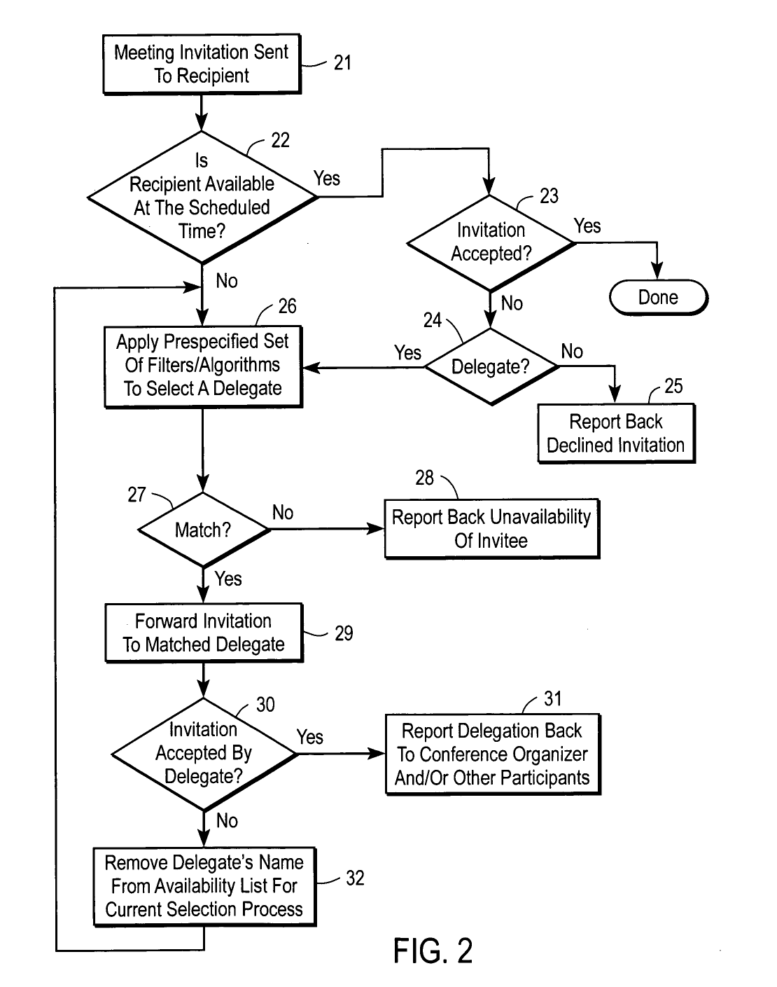

FIG. 2 illustrates an example method for auto-scheduling a conference session where an invitee may be unavailable at a scheduled time. The process begins at block 21 with the sending of the meeting invitation by the scheduler to the recipient invitee. As previously discussed, the invitation may comprise an email message having a subject field and body that includes a scheduled meeting time and other relevant information pertaining to the meeting. The invitation message may also have a priority setting. The invitation may be sent by any available communication system or method.

Next, an inquiry is made regarding the availability of the recipient invitee at the scheduled time (block 22). This may involve the calendaring program or email client of the recipient, upon receiving the invitation, sending a reply message indicating that the invitee is available or not. For instance, if the recipient is available, he may personally accept or decline the invitation (block 23) via a reply email sent to the scheduler. If the invitation is declined, the recipient may delegate attendance to someone else (block 24) or simply decline the invitation (block 25).

In the event that the recipient invitee is unavailable or otherwise elects to delegate attendance at the meeting to another person, the invitee's pre-specified set of filtering rules are fetched and applied to the invitation in order to select a delegate to attend the meeting in their place (block 26). If a match (block 27) between some context or content—e.g., key words, phrases, priority setting, scheduled time/date, etc.—of the invitation and an entry in the list of delegates identified by application of the filtering rules is found, the invitation is forwarded to the matched delegate (block 29). Conversely, if no match is found and no default delegate has been designated by the user, a message is sent back to the scheduler reporting of the unavailability of the invitee with no delegation (block 28).

After forwarding of the invitation, the delegate has the ability to accept or decline the invitation (block 30). This may occur automatically, as in the case where the delegate is on vacation or is otherwise unavailable in the same manner described above. Acceptance of the forwarded invitation by the delegate results in a message sent back to the scheduler as well as the conference organizer and/or other conference participants (block 31). For instance, the message may inform each conference participant that the original invitee (Bob) is unavailable, and a delegate (Tom) will attend in his place. Alternatively, should the forwarded invitation be declined by the delegate, the delegate's name may be removed from the list of available delegates for attendance at this meeting only (block 32). The algorithmic process of applying the filtering rules to the content/context of the invitation message is the repeated (block 26).

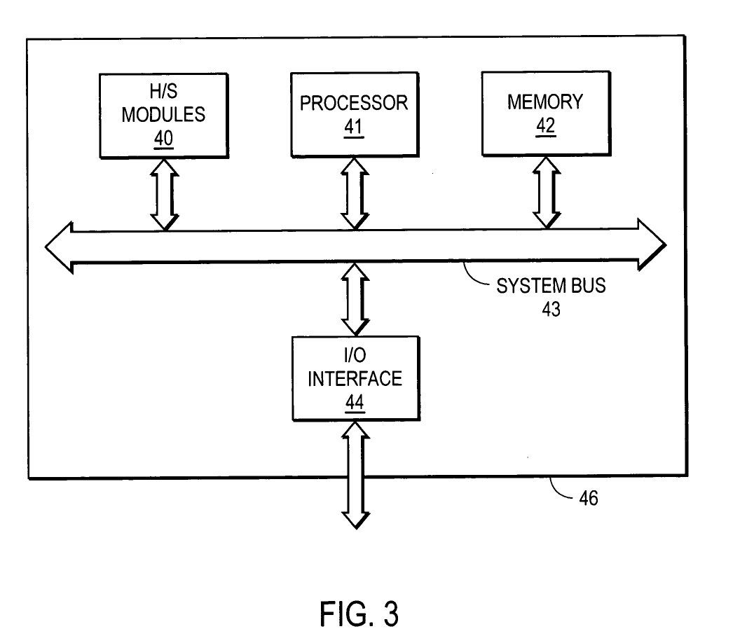

FIG. 3 is a generalized block diagram showing an example network device 46, such as may comprise any of the devices shown or described in conjunction with FIG. 1. Device 46 includes a processor subsystem 41 coupled with a memory unit 42, one or more hardware/software modules 40, and an input/output (I/O) interface 44 via a system bus 43. Modules 40 may include software or hardware (firmware) for implementing any of the functions described herein, e.g., those functions associated with scheduling of a meeting and delegation of invitees/attendees, including selection of delegates based on a predefined or specified set of filters/selection algorithms.

It is appreciated that any scheduling, calendar, or conferencing system utilized by or in conjunction with device 46 may comprise separate hardware devices coupled to the system bus 43, or, alternatively, implemented as software programs or modules 40 that run on one or more processors of subsystem 41. In other words, the scheduling, calendaring, conference management, and other functions may be implemented as separate hardware devices, memory locations (storing executable code), firmware devices, software modules, or other machine-readable devices. (In the context of the present application, therefore, the term “module” is to be understood as being synonymous with both hardware devices and computer-executable software code, programs or routines.)

It should be further understood that elements of the present invention may also be provided as a computer program product which may include a machine-readable medium having stored thereon instructions which may be used to program a computer (e.g., a processor or other electronic device) to perform a sequence of operations. Alternatively, the operations may be performed by a combination of hardware and software. The machine-readable medium may include, but is not limited to, floppy diskettes, optical disks, CD-ROMs, and magneto-optical disks, ROMs, RAMs, EPROMs, EEPROMs, magnet or optical cards, propagation media or other type of media/machine-readable medium suitable for storing electronic instructions. For example, elements of the present invention may be downloaded as a computer program product, wherein the program may be transferred from a remote computer or telephonic device to a requesting process by way of data signals embodied in a carrier wave or other propagation medium via a communication link (e.g., a modem or network connection).

Additionally, although the present invention has been described in conjunction with specific embodiments, numerous modifications and alterations are well within the scope of the present invention. For instance, although functions and elements of the present invention have been described as being embodied on a scheduling and/or conferencing application, client, or server, it is appreciated that these same elements and functions may be embodied on an email server or client, or other types of applications, clients, or servers. Accordingly, the specification and drawings are to be regarded in an illustrative rather than a restrictive sense.

We claim:

1. A method comprising:
sending a first electronic communication inviting an individual to attend a conference session to be held at a specified time over a network;
receiving an automatic response to the first electronic communication indicating that the individual is unavailable at the specified time;
applying an algorithm to select a delegate to attend the conference session in place of the individual, selection being based on a predefined criteria; and
sending a second electronic communication inviting the delegate to attend the conference session.

2. The method of claim 1 wherein the predefined criteria is specific to the individual.

3. The method of claim 1 wherein the algorithm is applied to the first electronic communication.

4. The method of claim 1 wherein the criteria comprises a content of the first electronic communication, the content including a message subject and a message body.

5. The method of claim 4 wherein the criteria further comprises a priority of the first electronic communication.

6. The method of claim 4 wherein the criteria further comprises the specified time of the conference session.

7. The method of claim 1 further comprising:
receiving an automatic response to the second electronic communication indicating that the delegate is unavailable at the specified time;
applying the algorithm to select a new delegate to attend the conference session in place of the delegate;
sending a third electronic communication inviting the new delegate to attend the conference session.

8. The method of claim 1 wherein the selection is based on matching of the predefined criteria to each one of a pool of potential delegates.

9. The method of claim 1 wherein the algorithm comprises a set of filtering rules.

10. A method comprising:
sending an electronic invitation to an endpoint associated with a user, the electronic invitation requesting that the user attend a conference session to be held at a specified time over a network;
applying a set of filtering rules to the electronic invitation to select a delegate to attend the conference session in place of the user; and
forwarding the electronic invitation to the delegate.

11. The method of claim 10 wherein the set of filtering rules is specific to the user.

12. The method of claim 10 wherein the set of filtering rules apply to a content of the electronic invitation.

13. The method of claim 12 wherein the content includes a message subject and a message body.

14. The method of claim 12 wherein applying the set of filtering rules comprises matching of a word or a phrase in the content with a list of words and phrases stored in a database, each entry in the list being associated with one or more delegates.

15. The method of claim 10 wherein the set of filtering rules apply to a priority of the electronic invitation.

16. The method of claim 10 wherein the set of filtering rules apply to the specified time.

17. The method of claim 10 further comprising:
receiving an automatic response to the electronic invitation indicating that the delegate is unavailable at the specified time;
applying the set of filtering rules to select a new delegate to attend the conference session in place of the delegate;
forwarding the electronic invitation to the new delegate.

18. Logic encoded in one or more media for execution and when executed is operable to:
schedule a meeting at a specified time in response to a request from a meeting organizer;
send an electronic invitation to an endpoint associated with a user, the electronic invitation requesting that the user attend the meeting at a specified time; and
forward the electronic invitation to a delegate selected to attend the meeting in place of the user, the delegate being selected by application of a set of filtering rules to the electronic invitation.

19. The logic of claim 18 wherein the delegate is selected in response to an indication that the user is unavailable at the specified time.

20. The logic of claim 18 wherein the logic, when executed, is further operable to forward the electronic invitation to a new delegate selected to attend the meeting in place of the delegate, the new delegate being selected by application of the set of filtering rules to the electronic invitation.

21. The logic of claim 18 wherein the set of filtering rules is specific to the user.

22. The logic of claim 18 wherein the set of filtering rules apply to a content of the electronic invitation.

23. The logic of claim 18 wherein the set of filtering rules apply to a priority of the electronic invitation.

24. The logic of claim 18 wherein the set of filtering rules apply to the specified time.

25. A system comprising:
a conference server; and
a scheduler operable, in response to input from an endpoint associated with a meeting organizer, to schedule a meeting conducted among a group of invitees via the conference server at a specified time, the scheduler being operable to send an electronic invitation to endpoints of the invitees, the scheduler being further operable to forward the electronic invitation to a delegate selected to attend the meeting in place of an particular invitee responsive to input received indicating that the particular invitee is unavailable at the specified time, the delegate being selected by application of a set of filtering rules to the electronic invitation.

26. The system of claim 25 wherein the set of filtering rules is specific to the particular invitee.

27. The system of claim 25 wherein the set of filtering rules apply to a content of the electronic invitation.

28. The system of claim 27 wherein the content includes a message subject and a message body.

29. The system of claim 27 further comprising a database that stores a list of words and phrases, each entry in the list being associated with one or more delegates, selection of the delegate resulting from a match of a word or a phrase in the content with an entry in the list.

30. The system of claim 25 wherein the set of filtering rules apply to a priority of the electronic invitation.

31. The system of claim 25 wherein the set of filtering rules apply to the specified time.
